(19) United States
(12) Patent Application Publication
(10) Pub. No.: US 2026/0155919 A1
(43) Pub. Date: Jun. 4, 2026

(54) ENTITY FOR GENERATING A SIGNAL AND ENTITY FOR GENERATING AN ORTHOGONAL FREQUENCY-DIVISION MULTIPLEXING SIGNAL

(71) Applicant: HUAWEI TECHNOLOGIES CO., LTD., Shenzhen (CN)

(72) Inventors: Fabien HELIOT, Guildford (GB); Fan Wang, Shanghai (CN)

(21) Appl. No.: 19/426,920

(22) Filed: Dec. 19, 2025

Related U.S. Application Data
(63) Continuation of application No. PCT/CN2023/101947, filed on Jun. 21, 2023.

(51) Int. Cl. H04L 5/00; H04B 7/06

(52) U.S. Cl. CPC H04L 5/0007; H04B 7/0634

(57) ABSTRACT

The present disclosure relates to an entity for generating a signal. The entity is configured to generate the signal by precoding a vector, the vector comprising a group of real elements and an offset. The entity is configured to obtain the group of real elements from an orthogonal frequency-division multiplexing (OFDM) signal, and the offset from the group of real elements. Further, the present disclosure relates to an entity for generating an orthogonal frequency-division multiplexing (OFDM) signal. The entity is configured to generate the OFDM signal by grouping samples of a signal in multiple groups, and postcoding each group of the multiple groups to generate postcoded samples of the signal.

### CROSS-REFERENCE TO RELATED APPLICATIONS

This application is a continuation of International Application No. PCT/CN2023/101947, filed on Jun. 21, 2023, the disclosure of which is hereby incorporated by reference in its entirety.

### TECHNICAL FIELD

The present disclosure relates to an entity and method for generating a signal, and more particularly, to an entity and method for generating an orthogonal frequency-division multiplexing (OFDM) signal.

### BACKGROUND

Orthogonal frequency-division multiplexing (OFDM) is a technique used in wireless communication of data. It may be used in optical communication, such as visible light communication, sub-Terahertz (sub-THz) communication, Terahertz (THz) communication etc. OFDM in optical communication may be referred to as optical OFDM (O-OFDM).

OFDM schemes may be based on direct current-biasing optical OFDM (DCO-OFDM) and/or asymmetrically clipped optical OFDM (ACO-OFDM). Another O-OFDM scheme is layered ACO-OFDM (LACO-OFDM) for improving spectral efficiency (SE). LACO-OFDM uses a superposition of data layers at the transmitter and an iterative decoding structure (similar to successive interference cancelation (SIC)) at the receiver. The above O-OFDM schemes have a great implementation complexity and a relatively high peak to average-power ratio (PAPR).

### SUMMARY OF EXAMPLE EMBODIMENTS

In view of the above, this disclosure aims to provide an entity that allows with regard to efficiency and complexity an improved conversion of an OFDM signal into a signal suitable for intensity modulated and direct detection (IMDD) based optical communication. An objective of this disclosure is to provide such an entity with an improved tradeoff between at least two of the following performance metrics compared to LACO-OFDM: spectral efficiency (SE), bit-error-rate (BER), peak-to-average power ratio (PAPR) and computational complexity.

These and other objectives are achieved by the solution of this disclosure as described in the independent claims. Advantageous implementations are further defined in the dependent claims.

A first aspect of this disclosure provides an entity for generating a signal. The entity is configured to generate the signal by precoding a vector, the vector comprising a group of real elements and an offset. The entity is configured to obtain the group of real elements from an orthogonal frequency-division multiplexing (OFDM) signal, and the offset from the group of real elements.

In other words, the first aspect provides an entity that is configured to generate a signal by converting an OFDM signal to the signal. The entity may use linear algebra (precoding) and direct current biasing (obtain offset) for converting an OFDM signal to a signal that is suitable for intensity modulated and direct detection (IMDD) based optical communication. Direct detection may comprise or may be envelope detection.

Thus, the entity allows a conversion of an OFDM signal to a signal suitable for IMDD based optical communication that is improved with regard to efficiency and complexity. The entity allows such a conversion with, compared to LACO-OFDM, double SE granularity, reduced PAPR by several dBs (e.g. 2.5 dBs for the same SE and BER performance), and a reduced complexity by one order of magnitude for the same SE and BER performance.

The entity may be software and/or hardware. The entity may be a communication device, such as an optical communication device. That is, the entity may be configured for wireless communication. The entity may be configured for optical communication, such as visible light communication, sub-Terahertz (sub-THz) communication, Terahertz (THz communication) etc. For example, the entity may be a transmitter or a transceiver. The entity provides with the signal a signal that is suitable for intensity modulated and direct detection (IMDD) based optical communication. That is, the entity allows an IMDD based optical communication. The OFDM signal may be a radio frequency OFDM (RF OFDM) signal. The offset may be a DC offset.

The terms “derive” and “obtain” may be used as synonyms. The phrase “the entity is configured to obtain the group of real elements from the OFDM signal” may comprise that the entity is configured to compute the real elements from the OFDM signal, and/or extract the real elements from the OFDM signal and/or receive the real elements. The phrase “the entity is configured to obtain the offset from the group of real elements” may comprise that the entity is configured to compute the offset from the real elements, and/or extract the offset from the real elements and/or receive the offset.

In an implementation form of the first aspect, the entity is configured to transmit the signal. That is, the entity may be configured to generate and transmit the signal.

The entity may be configured to transmit the signal to another entity. The entity may be configured to transmit the signal by wireless communication, for example by optical communication.

In an implementation form of the first aspect, the entity is configured to obtain the vector by grouping samples of the OFDM signal in multiple groups, and obtaining the offset for each group of the multiple groups.

The offset (of the vector) may be or may comprise multiple single offsets for the multiple groups, wherein each single offset of the multiple single offsets is obtained for a respective group of the multiple groups. The multiple single offsets may be multiple DC offsets. In other words, the entity may be configured to obtain the vector by grouping samples of the OFDM signal in multiple groups and obtaining for each group of the multiple groups a respective single offset, wherein the respective single offsets obtained for the multiple groups may form the offset of the vector. The samples of the OFDM signal may be referred to as “OFDM samples”.

The entity may be configured to precode the vector by precoding the multiple groups of OFDM samples (e.g. in time domain) and applying a respective single offset (e.g. single DC offset) to each of the multiple groups of OFDM signals.

In an implementation form of the first aspect, the entity is configured to precode the vector by multiplying the vector with a precoding matrix; and the column or row vectors of the precoding matrix are linearly independent.

In an implementation form of the first aspect, the entity is configured to obtain the vector by separating a real part and an imaginary part of N samples of the OFDM signal, wherein N is a positive integer, generating 2N real elements comprising the real part and imaginary part of the N samples of the OFDM signal, grouping the 2N real elements in multiple groups, and obtaining the offset for each group of the multiple groups.

The offset may be or may comprise multiple single offsets for the multiple groups, wherein each single offset of the multiple single offsets is obtained for a respective group of the multiple groups.

N may equal a number of OFDM subcarriers of the OFDM signal. The vector may comprise the group of real elements in multiple groups. The vector may comprise the multiple single offsets for the multiple groups as the offset.

The entity may be configured to obtain the offset for each group of the multiple groups by adding a respective real scalar element as an additional sample to each group of the multiple groups. That is, each single offset of the multiple single offsets may be a respective real scalar element obtained for the respective group of the multiple groups. The real scalar element may be referred to as “direct current offset value (DC offset value)”. The entity may be configured to generate the respective real scalar element for each group by using one or more samples of the group.

In an implementation form of the first aspect, the entity is configured to transmit the signal to a second entity, and provide to the second entity at least one of the following: information on a length of the vector, information on the precoding matrix, and information on the offset.

The entity and the second entity may be entities of a communication network, e.g. optical communication network. The second entity may be a communication device, such as an optical communication device. That is, the second entity may be configured for wireless communication. The second entity may be configured for optical communication, such as visible light communication, sub-Terahertz (sub-THz) communication, Terahertz (THz communication) etc. For example, the second entity may be a receiver or a transceiver.

In an implementation form of the first aspect, the signal is a real nonnegative signal.

A real nonnegative signal is a signal comprising one or more symbols that are real numbers being nonnegative. That is, the one or more symbols have real nonnegative values.

A real number that is greater than or equal to zero is a nonnegative real number. The term “real unipolar signal” may be used as a synonym for the term “real nonnegative signal”. That is, the entity may convert the OFDM signal to a unipolar signal.

In order to achieve the entity according to the first aspect of the disclosure, some or all of the implementation forms and optional features according to the first aspect, as described above, may be combined with each other.

A second aspect of this disclosure provides an entity for generating an orthogonal frequency-division multiplexing (OFDM) signal. The entity is configured to generate the OFDM signal by grouping samples of a signal in multiple groups, and postcoding each group of the multiple groups to generate postcoded samples of the signal.

The above description of the entity according to the first aspect is correspondingly valid for the entity according to the second aspect.

The entity according to the second aspect may be the entity according to the first aspect. That is, the entity according to the second aspect may be configured according to the description of the entity according to the first aspect.

The entity according to the second aspect may be configured to postcode each group of the multiple groups using a reverse of a precoding matrix, which is used for precoding the OFDM signal to generate the postcoded samples of the signal. The entity may be a communication device, such as an optical communication device. That is, the entity may be configured for wireless communication. The entity may be configured for optical communication, such as visible light communication, sub-Terahertz (sub-THz) communication, Terahertz (THz communication) etc. For example, the entity may be a receiver or a transceiver.

The signal may be a signal that is suitable for intensity modulated and direct detection (IMDD) based optical communication. That is, the entity allows an IMDD based optical communication. The OFDM signal may be a radio frequency OFDM (RF OFDM) signal.

In an implementation form of the second aspect, the entity is configured to receive the signal.

The entity is configured for intensity modulated and direct detection (IMDD) based optical communication by being configured to receive the signal. That is, the entity allows an IMDD based optical communication.

That is, the entity may be configured to receive the signal and convert the signal to the OFDM signal. The entity may be configured to receive the signal from another entity. The entity may be configured to receive the signal by wireless communication, for example by optical communication.

In an implementation form of the second aspect, the entity is configured to generate the OFDM signal by removing from each postcoded group a respective real scalar element, which is a respective single offset.

In an implementation form of the second aspect, the entity is configured to concatenate each postcoded group without the removed respective real scalar element.

In other words, the entity may be configured to concatenate the multiple groups after the multiple groups are postcoded and the respective real scalar elements is removed from the multiple groups.

In an implementation form of the second aspect, the entity is configured to generate N samples of the OFDM signal each comprising complex values by using each postcoded group without the removed respective real scalar element. N may equal a number of OFDM subcarriers of the OFDM signal.

In an implementation form of the second aspect, the entity is configured to receive at least one of the following: information on a group length associated with a group of the multiple groups, information on a precoding matrix, and information on a respective single offset associated with the group of the multiple groups.

Optionally, the entity is configured to receive at least one of the following: information on a respective group length associated with each group of the multiple groups, information on a precoding matrix, and information on a respective single offset associated with each group of the multiple groups.

In an implementation form of the second aspect, the signal is a real nonnegative signal.

The entity according to the second aspect and its implementation forms and optional features achieve the same advantages as the entity according to the first aspect and its respective implementation forms and respective optional features.

In order to achieve the entity according to the second aspect of the disclosure, some or all of the implementation forms and optional features of the second aspect, as described above, may be combined with each other.

A third aspect of this disclosure provides a method for generating a signal. The method comprises generating the signal by precoding a vector, the vector comprising a group of real elements and an offset. The method comprises obtaining the group of real elements from an orthogonal frequency-division multiplexing (OFDM) signal, and the offset from the group of real elements.

In an implementation form of the third aspect, the method comprises transmitting the signal.

In an implementation form of the third aspect, the method comprises obtaining the vector by grouping samples of the OFDM signal in multiple groups, and obtaining the offset for each group of the multiple groups.

In an implementation form of the third aspect, the method comprises precoding the vector by multiplying the vector with a precoding matrix; and the column or row vectors of the precoding matrix are linearly independent.

In an implementation form of the third aspect, the method comprises obtaining the vector by separating a real part and an imaginary part of N samples of the OFDM signal, wherein N is a positive integer, generating 2N real elements comprising the real part and imaginary part of the N samples of the OFDM signal, grouping the 2N real elements in multiple groups, and obtaining the offset for each group of the multiple groups.

In an implementation form of the third aspect, the method comprises transmitting the signal to an entity, and providing to the entity at least one of the following: information on a length of the vector, information on the precoding matrix, and information on the offset.

In an implementation form of the third aspect, the signal is a real nonnegative signal.

The above description of the entity according to the first aspect is correspondingly valid for the method according to the third aspect.

The method according to the third aspect and its implementation forms and optional features achieve the same advantages as the entity according to the first aspect and its respective implementation forms and respective optional features.

In order to achieve the method according to the third aspect of the disclosure, some or all of the implementation forms and optional features of the third aspect, as described above, may be combined with each other.

A fourth aspect of this disclosure provides a method for generating an orthogonal frequency-division multiplexing (OFDM) signal. The method comprises generating the OFDM signal by grouping samples of a signal in multiple groups, and postcoding each group of the multiple groups to generate postcoded samples of the signal.

Optionally, the method comprises postcoding each group of the multiple groups using a reverse of a precoding matrix, which is used for precoding the OFDM signal to generate the samples of the signal.

In an implementation form of the fourth aspect, the method comprises receiving the signal.

In an implementation form of the fourth aspect, the method comprises generating the OFDM signal by removing from each postcoded group a respective real scalar element, which is a respective single offset.

In an implementation form of the fourth aspect, the method comprises concatenating each postcoded group without the removed respective real scalar element.

In an implementation form of the fourth aspect, the method comprises generating N samples of the OFDM signal each comprising complex values by using each postcoded group without the removed respective real scalar element.

In an implementation form of the fourth aspect, the method comprises receiving at least one of the following: information on a group length associated with a group of the multiple groups, information on a precoding matrix, and information on a respective single offset associated with the group of the multiple groups.

In an implementation form of the fourth aspect, the signal is a real nonnegative signal.

The above description of the entity according to the second aspect is correspondingly valid for the method according to the fourth aspect.

The method according to the fourth aspect and its implementation forms and optional features achieve the same advantages as the entity according to the first aspect and its respective implementation forms and respective optional features.

In order to achieve the method according to the fourth aspect of the disclosure, some or all of the implementation forms and optional features of the fourth aspect, as described above, may be combined with each other.

A fifth aspect of this disclosure provides a computer program comprising instructions which, when the program is executed by a computer, cause the computer to perform the method according to the third aspect or any of its implementation forms; or the method according to the fourth aspect or any of its implementation forms.

A sixth aspect of this disclosure provides a storage medium storing executable program code which, when executed by a processor, causes the method according to the third aspect or any of its implementation forms; or the method according to the fourth aspect or any of its implementation forms to be performed.

The computer program according to the fifth aspect and the storage medium according to the sixth aspect achieve the same advantages as the entity according to the first aspect and its respective implementation forms and respective optional features.

It has to be noted that all devices, elements, units and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms are explained in the following description of specific embodiments in relation to the enclosed drawings listed below.

FIG. 1 shows an example of an entity according to this disclosure for generating a signal.

FIG. 2 shows an example of an entity according to this disclosure for generating an orthogonal frequency-division multiplexing (OFDM) signal.

FIG. 3 shows an example of a method according to this disclosure for generating a signal.

FIG. 4 shows an example of a method according to this disclosure for generating an orthogonal frequency-division multiplexing (OFDM) signal.

FIG. 5 shows an example of an implementation form of the entity of FIG. 1 and the entity of FIG. 2.

FIG. 6 shows an example of a function of a part of the entities of FIG. 5.

FIG. 7 shows a spectral efficiency (SE) performance for an example of O-OFDM according to this disclosure compared to ACO-OFDM, DCO-OFDM and LACO-OFDM.

FIG. 8 shows a bit-error-rate (BER) performance for an example of O-OFDM according to this disclosure compared to ACO-OFDM, DCO-OFDM and LACO-OFDM.

FIG. 9 shows a peak to average-power ratio (PAPR) performance for an example of O-OFDM according to this disclosure compared to ACO-OFDM, DCO-OFDM and LACO-OFDM.

FIG. 10 shows a computational complexity for an example of O-OFDM according to this disclosure compared to LACO-OFDM.

Corresponding elements may be labelled by the same reference sign.

### DETAILED DESCRIPTION OF EXAMPLE EMBODIMENTS

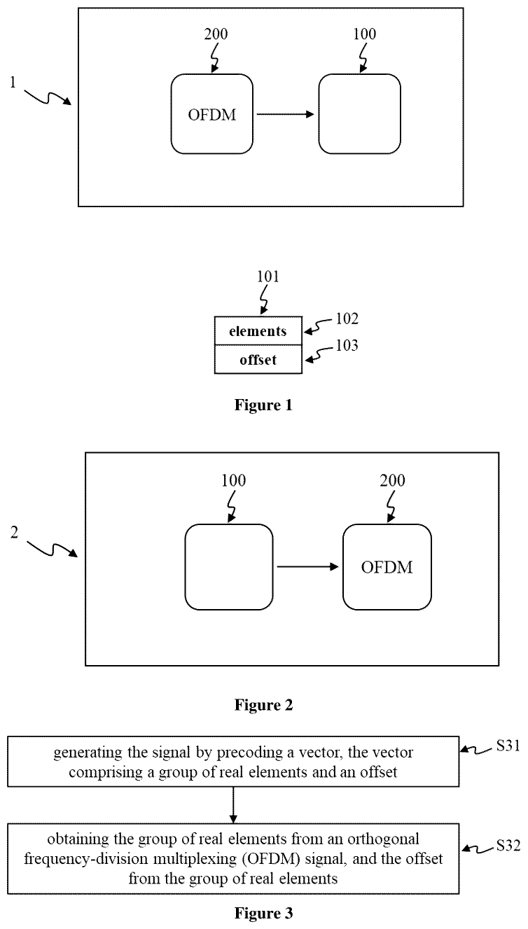

FIG. 1 shows an example of an entity according to this disclosure for generating a signal. The entity 1 of FIG. 1 is an example of the entity according to the first aspect of this disclosure. The description of the entity according to the first aspect is correspondingly valid for the entity 1 of FIG. 1.

The entity 1 of FIG. 1 is an entity for generating a signal 100. The entity 1 is configured to generate the signal 100 by precoding a vector 101, the vector 101 comprising a group 102 of real elements “elements” and an offset 103 “offset”. The entity 1 is configured to obtain the group 102 of real elements from an orthogonal frequency-division multiplexing (OFDM) signal 200, and the offset 103 from the group 102 of real elements.

The signal 100 may be a signal that is suitable for intensity modulated and direct detection (IMDD) based optical communication. That is, the entity 1 allows an IMDD based optical communication. The OFDM signal 200 may be a radio frequency OFDM (RF OFDM) signal.

The entity 1 may be a communication device, such as an optical communication device. That is, the entity 1 may be configured for wireless communication. The entity 1 may be configured for optical communication, such as visible light communication, sub-Terahertz (sub-THz) communication, Terahertz (THz communication) etc. For example, the entity 1 may be a transmitter or a transceiver.

The entity 1 may comprise a processor or processing circuitry (not shown) configured to perform, conduct or initiate the various operations of the entity 1 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The entity 1 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the entity to be performed. In one embodiment, the processing circuitry comprises one or more processors and a non-transitory memory connected to the one or more processors. The non-transitory memory may carry executable program code which, when executed by the one or more processors, causes the entity 1 to perform, conduct or initiate the operations or methods described herein.

The entity 1 may be configured to transmit the signal 100 to another entity. The other entity may be for example the entity 2 of FIG. 2. The entity 1 may be configured to transmit the signal by wireless communication, for example by optical communication.

For further details on the entity 1 of FIG. 1 reference is made to the description of the entity according to the first aspect and to the description of FIGS. 2 to 10.

FIG. 2 shows an example of an entity according to this disclosure for generating an orthogonal frequency-division multiplexing (OFDM) signal. The entity 2 of FIG. 2 is an example of the entity according to the second aspect of this disclosure. The description of the entity according to the second aspect is correspondingly valid for the entity 2 of FIG. 2.

The entity 2 of FIG. 2 is an entity for generating an orthogonal frequency-division multiplexing (OFDM) signal 200. The entity 2 is configured to generate the OFDM signal 200 by grouping samples of a signal 100 in multiple groups, and postcoding each group of the multiple groups to generate postcoded samples of the signal 100.

The signal 100 may be a signal that is suitable for intensity modulated and direct detection (IMDD) based optical communication. That is, the entity 2 allows an IMDD based optical communication. The OFDM signal 200 may be a radio frequency OFDM (RF OFDM) signal.

The entity 2 may be a communication device, such as an optical communication device. That is, the entity 2 may be configured for wireless communication. The entity 2 may be configured for optical communication, such as visible light communication, sub-Terahertz (sub-THz) communication, Terahertz (THz communication) etc. For example, the entity 2 may be a receiver or a transceiver.

The entity 2 may comprise a processor or processing circuitry (not shown) configured to perform, conduct or initiate the various operations of the entity 2 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The entity 2 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the entity to be performed. In one embodiment, the processing circuitry comprises one or more processors and a non-transitory memory connected to the one or more processors. The non-transitory memory may carry executable program code which, when executed by the one or more processors, causes the entity 2 to perform, conduct or initiate the operations or methods described herein.

The entity 2 may be configured to receive the signal from another entity. The other entity may be the entity 1 of FIG. 1. The entity 2 may be configured to receive the signal by wireless communication, for example by optical communication.

Optionally, the entity 2 of FIG. 2 is an example of an implementation form of the entity 1 of FIG. 1. That is, the features of the entity 1 of FIG. 1 may optionally be implemented in the entity 2 of FIG. 2.

For further details on the entity 2 of FIG. 2 reference is made to the description of the entity according to the second aspect and to the description of FIGS. 1 and 3 to 10.

FIG. 3 shows an example of a method according to this disclosure for generating a signal. The method of FIG. 3 is an example of the method according to the third aspect of this disclosure. The description of the method according to the third aspect is correspondingly valid for the method of FIG. 3.

The method of FIG. 3 is a method for generating a signal. The method comprises, in a step S31, generating the signal by precoding a vector, the vector comprising a group of real elements and an offset. The method comprises, in a step S32 following the step S31, obtaining the group of real elements from an orthogonal frequency-division multiplexing (OFDM) signal, and the offset from the group of real elements.

The entity 1 of FIG. 1 is configured to perform the method of FIG. 3. For further details on the method of FIG. 3 reference is made to the description of the method according to the third aspect of this disclosure and the description of FIGS. 5 to 10.

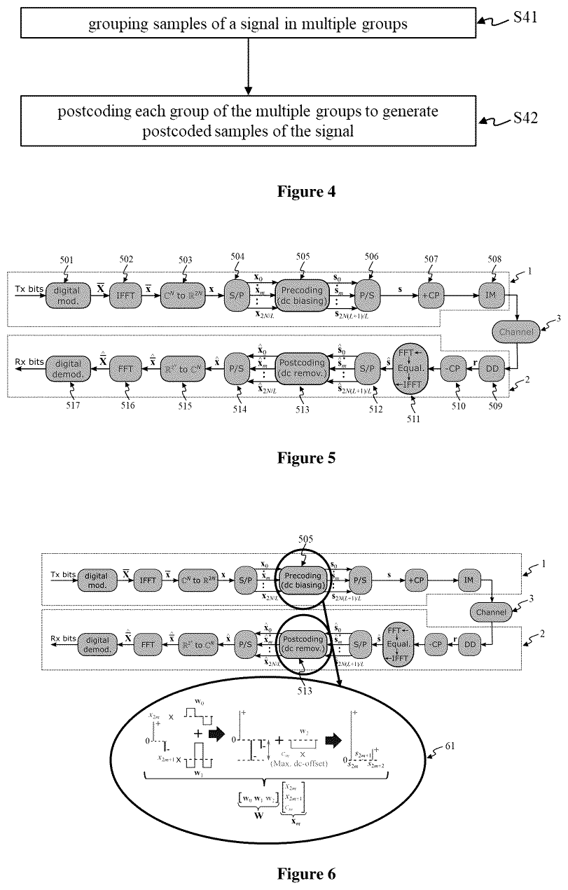

FIG. 4 shows an example of a method according to this disclosure for generating an orthogonal frequency-division multiplexing (OFDM) signal. The method of FIG. 4 is an example of the method according to the fourth aspect of this disclosure. The description of the method according to the fourth aspect is correspondingly valid for the method of FIG. 4.

The method of FIG. 4 is a method for generating an orthogonal frequency-division multiplexing (OFDM) signal. The method comprises generating the OFDM signal by grouping, in a step S41, samples of a signal in multiple groups, and postcoding, in a step S42 following the step S41, each group of the multiple groups to generate postcoded samples of the signal.

The entity 2 of FIG. 2 is configured to perform the method of FIG. 4. For further details on the method of FIG. 4 reference is made to the description of the method according to the fourth aspect of this disclosure and the description of FIGS. 5 to 10.

FIG. 5 shows an example of an implementation form of the entity of FIG. 1 and the entity of FIG. 2.

In the example of FIG. 5, it is assumed that the entity 1 of FIG. 1 transmits, by optical communication, a signal via a channel 3 to the entity 2 of FIG. 2. That is, it is assumed that the entity 1 is a transmitter or transceiver, and the entity 2 is a receiver or transceiver. The blocks 501 to 508 of FIG. 5 show functions of the entity 1 and the blocks 509 to 517 of FIG. 5 show functions of the entity 2.

As shown in FIG. 5, a stream of bits Tx to be transmitted by the entity 1 may be digital modulated 501 to form a stream of symbols X̅. The stream of symbols X̅ may be generated from the stream of bits Tx through a M-ary digital modulation, such as a quadrature amplitude modulation (QAM). An OFDM signal x̅ may be generated by the inverse discrete Fourier transform/inverse fast Fourier transform (IFFT) 502 from the stream of symbols X̅, as follows:

$$\overline{{x}_{n}} = \frac{1}{\sqrt{N}} {\sum }_{k = 0}^{N - 1} {X}_{k} {e}^{j \frac{2 π kn}{N}} ( n ∈ 𝒩 ) \qquad ( 1 )$$

The OFDM signal x̅ may be a radio frequency (RF) OFDM signal. In the above equation (1), [symbol] ={0, 1, . . . , N−1}, x̅ₙ̅ is the n-th sample of the IFFT time-domain signal, X̅ₖ is the k-th symbol of the stream of symbols X̅ converted from the stream of bits Tx through a M-ary digital modulation, e.g. a quadrature amplitude modulation (QAM). N is the number of OFDM subcarriers and j≙\sqrt{−1}. Given that x̅ₙ̅ is generated via IFFT, x̅ₙ̅∈X, such that x̅ₙ̅= [symbol] {x̅ₙ̅}+j [symbol] {x̅ₙ̅}, where [symbol] {⋅} and [symbol] {⋅} return the real and imaginary parts of a complex number, respectively. In order to convert the IFFT time-domain samples, i.e. where each [symbol] {x̅ₙ̅}∈P and [symbol] {x̅ₙ̅}∈P have distinct amplitudes and polarities, into a signal suitable for IMDD based optical communication, e.g. a real nonnegative (unipolar) signal suitable for optical communication, the conversion process based on precoding and DC biasing may be implemented as presented by the blocks 503 to 505 of FIG. 5. The signal processing represented by one or both of the blocks 501 and 502, i.e. the conversion of the stream of bits Tx to the stream of symbols X̅ by digital modulation 501 and the generation of the OFDM signal x̅ by the IFFT 502 from the stream of symbols X̅ may optionally be done outside the entity 1. In this optional case, the entity 1 may receive the OFDM signal x̅ as an input.

Let x̅∈X be a column vector that contains the N samples of the IFFT signal of above equation (1). As shown in FIG. 5, a step 503 of the conversion process of the OFDM signal x̅ to the signal to be transmitted by the entity 1, comprises separating the real and imaginary parts of each element of X to create a vector of real values, i.e. x=[ [symbol] {x̅₀̅}, [symbol] {x̅₁̅}, . . . , [symbol] {x̅_̅{̅N̅-̅1̅}̅}, [symbol] {x̅₀̅}, [symbol] {x̅₁̅}, . . . , [symbol] {x̅_̅{̅N̅-̅1̅}̅}]^{T}∈P^{2N}, having 2N real elements instead of N complex ones, wherein [⋅]^{T} is the matrix transpose operator. Then, in a step 504 (represented in FIG. 5 by the functional block “S/P”, the abbreviation “S/P” meaning “serial to parallel conversion”), 2N/L subgroups of L elements (samples) of x are formed and, in a step 505, a real scalar element, cₘ, is inserted into each sub-group xₘ, as follows:

$${x}_{m} = {[ {x}_{mL} , {x}_{mL + 1} , , {x}_{( m + 1 ) L - 1} , {c}_{m} ]}^{T} ( m ∈ ℳ ) \qquad ( 2 )$$

The terms “elements” and “samples” may be used as synonyms. In the above equation (2), M={0, 1, . . . , 2N/L−1} and cₘ is the DC offset of the m-th sub-group.

In other words, the entity 1 may be configured to obtain a vector x comprising a group of real elements and an offset by grouping samples of the OFDM signal x̅ in multiple groups xₘ, and obtaining the offset for each group of the multiple groups xₘ. The offset (of the vector) may be or may comprise multiple single offsets cₘ for the multiple groups, wherein each single offset cₘ of the multiple single offsets is obtained for a respective group of the multiple groups xₘ.

As represented by the optional block 503, the entity 1 may be configured to obtain the vector x by separating a real part and an imaginary part of N samples of the OFDM signal x̅, wherein N is a positive integer, generating 2N real elements comprising the real part and imaginary part of the N samples of the OFDM signal x̅, grouping the 2N real elements in multiple groups xₘ, and obtaining the offset for each group of the multiple groups xₘ. The offset (of the vector) may be or may comprise multiple single offsets cₘ for the multiple groups xₘ, wherein each single offset of the multiple single offsets cₘ is obtained for a respective group of the multiple groups xₘ.

In order to obtain a vector of unipolar elements (i.e. nonnegative elements) out of xₘ∈P^{L+1}, in the step 505, each subgroup is precoded by using a unique precoding matrix W∈P^{(L+1)×(L+1)}, as follows:

$${s}_{m} = {Wx}_{m} . \qquad ( 3 )$$

The column or row vectors of the precoding matrix W may be linearly independent.

In other words, the entity 1 may be configured to precode a vector x comprising a group of real elements and an offset by multiplying the vector x with a precoding matrix W; and the column or row vectors of the precoding matrix W are linearly independent.

Subsequently, in a step 506 (represented in FIG. 5 by the functional block “P/S”, the abbreviation “P/S” meaning “parallel to serial conversion”), the 2N/L subgroups of real unipolar samples sₘ (i.e. real nonnegative samples) are concatenated together as

$$s = {[ {s}_{0} , {s}_{1} , … , {s}_{2 N / L} ]}^{T} \qquad ( 4 )$$

to form a signal s of 2N(L+1)/L samples suitable for intensity modulated (IM) transmission, i.e. to form a real unipolar baseband signal s (i.e. real nonnegative baseband signal). Optionally, in order to mitigate the effects of multipath propagation, in an optional step 507, a cyclic prefix (CP) of N* samples may be added to the signal s before the signal s is transmitted by the entity 1. Optionally, digital to analog conversion and filtering may be performed prior to IM transmission. The IM transmission of the signal s by the entity 1 is represented in FIG. 5 by the block 508.

For correct decoding the entity 2 may know the precoding matrix W. That is, the transmitter precoding matrix W may be known at the receiver side for correct decoding. This can be done by setting the same codebook of precoding matrices (e.g. lookup-table) at the transmitter side and the receiver side, i.e. at the entity 1 and the entity 2; and/or communicating (e.g. signaling) the precoding matrix W from the entity 1 to the entity 2, i.e. from the transmitter to the receiver.

The entity 1 may be configured to provide to the second entity 2 at least one of the following: information on a length of a vector x comprising a group of real elements and an offset, information on the precoding matrix W, and information on the offset.

The signal processing by the entity 1 may optionally be as follows: After IFFT processing (represented in FIG. 5 by the block 502), data may be separated into real and imaginary parts (represented in FIG. 5 by the block 503). Sub-groups of data may be formed (represented in FIG. 5 by the block 504) and precoded using a matrix (design of matrix may improve performance) representing an orthogonal basis (represented in FIG. 5 by the block 505). DC biasing may be calculated for each subgroup and may then be embedded into the transmit data (as overhead) via precoding (represented in FIG. 5 by the block 505).

That is, according to the signal processing of the entity 1, an offset (e.g. DC offset) may be calculated for each group of samples of multiple groups xₘ of samples, instead of having a pre-calculated offset (i.e. precalculated value) for multiple groups of samples and, thus, for all samples. The offset cₘ calculated for each group of samples of the multiple groups xₘ of samples may be encoded in the signal to be transmitted by the entity 1 (via precoding).

As shown in FIG. 5, the entity 2 of FIG. 2 may receive the signal s by direct detection (DD), represented by the block 509, and optionally may perform filtering and analog to digital conversion processes to obtain the received signal r that is of the form

$$r = s * h + n , \qquad ( 5 )$$

In the above equation (5), h is the channel impulse response, n represents the additive white Gaussian noise (AWGN), and “*” denotes the convolutional product. After the optional cyclic prefix (CP) is removed from r (represented by the block 510), the received signal r may go through discrete Fourier/fast Fourier transform (FFT), equalization and IFFT, such that the k-th sample of the time-domain received signal § after equalisation maybe expressed as

$${\hat{s}}_{n} = {s}_{k} + {\tilde{n}}_{k} ( k ∈ K ) , \qquad ( 6 )$$

In the above equation (6), K={0, 1, . . . , 2N(L+1)/L} and ñₖ is the k-th noise sample after equalization.

The negative part of ŝₖ may be clipped at the receiver, i.e. ŝₖ=[ŝₖ]₊ to make it unipolar (non-negative), wherein [⋅]₊ stands for max {⋅,0}. This may improve the detection performance given that the transmit signal is itself unipolar. The entity 2 may perform the process from the above equations (1) to (4) more or less in reverse order, as shown in the blocks 512 to 516. In other words, let ŝ=[ŝ₀, ŝ₁, . . . , ŝ_{2N(L+1)/L}]^{T}, then the postcoding (represented by block 513) may be as follows

$${x}_{m} = {W}^{- 1} {s}_{m} ( m ∈ M ) , \qquad ( 7 )$$

In the above equation (7), ŝₘ=[ŝ_{m(L+1)}, ŝ_{m(L+1)+1}, . . . , ŝ_{(m+1)(L+1)-2}, ŝ_{(m+1)(L+1)-1}]^{T}∈P^{L+1} is the m-th group of received samples extracted from ŝ. Subsequently, the vector \hat{x} is formed by concatenating the 2N/L groups of xₘ, but where the last term of each group, i.e. the DC offset value, is omitted, such that \hat{x}=[\hat{x}₀, \hat{x}₁, . . . , \hat{x}_{L-1}, \hat{x}_{L+1}, . . . , \hat{x}_{2L}, \hat{x}_{2L+2}, . . . , \hat{x}_{(2N/L-1)(L+1)-2}, \hat{x}_{(2N/L-1)(L+1)} . . . , \hat{x}_{(2N/L)(L+1)-2}]^{T}∈p^{2N}. In the block 515, the n-th received complex sample \overline{\hat{x}}ₙ may be formed from \hat{x}, as follows

$${\hat{\overline{x}}}_{n} = {\hat{x}}_{n} + j {\hat{x}}_{N + n} ( n ∈ 𝒩 ) . \qquad ( 8 )$$

It is then turned back into a digital modulation symbol \overline{\hat{X}} via FFT (represented by the block 516), which may be demodulated into bits, i.e. received bits Rx (represented by the block 517).

In other words, entity 2 is configured to generate an OFDM signal \overline{\hat{x}} by grouping samples of a signal s̅ in multiple groups s̅ₖ, and postcoding (step 513) each group of the multiple groups ŝₖ to generate postcoded samples of the signal ŝ. The entity 2 may be configured to generate the OFDM signal \overline{\hat{x}} by removing from each postcoded group a respective real scalar element, which is a respective single offset. The entity may be configured to concatenate each postcoded group without the removed respective real scalar element.

The entity 2 may be configured to generate (step 515) N samples \overline{\hat{X}} of the OFDM signal \overline{\hat{x}} each comprising complex values by using each postcoded group without the removed respective real scalar element. N may equal a number of OFDM subcarriers of the OFDM signal \overline{\hat{x}}.

Looking beyond the mathematics, the precoding process, represented by the above equation (3), is equivalent to spreading the value of each element of the elements of xₘ over L+1 samples (in the time domain) by means of L+1 spreading sequences. Each of these spreading sequences is represented by the L+1 columns of the precoding matrix W, i.e. wₗ, (l∈Λ={0, 1, . . . , L}). The resulting weighted sequences may be added together to form the elements of sₘ, which are real nonnegative elements. A simple example illustrates this concept in the circle 61 of FIG. 6 for the case of L=2. FIG. 6 shows an example of a function of a part of the entities of FIG. 5.

According to the circle 61 of FIG. 6, two samples of x, i.e. x₂ₘ and x₂ₘ₊₁, may be spread by the sequences w₀ and w₁ such that each sample is represented by three samples instead of one. The two spread sequences w₀ and w₁ may then be added together. Next, the value of the maximum offset for the w₀+w₁ sequence, i.e. cₘ, may be calculated and spread via w₂ before being added to the w₀+w₁ sequence to finally obtain a unipolar signal ready for transmission. Overall, this sample spreading process may be mathematically summarized as [w₀ w₁ w₂][x₂ₘx₂ₘ₊₁cₘ]^{T}.

The entities 1 and 2 of FIG. 6 are the entities 1 and 2 of FIG. 5 and, thus, the blocks 505 and 513 of FIG. 6 are the blocks 505 and 513 of FIG. 5, respectively. Therefore, the description of FIG. 5 is valid for FIG. 6.

Proposition 1: A necessary and sufficient condition for any elements of sₘ, i.e. s_{l,m} (l∈Λ), to be real nonnegative may be setting the value of the per sub-group DC offset, cₘ, as follows,

$${c}_{m} = {[ {max}_{l ∈ Λ} \{ - \frac{1}{{w}_{l , L}} {\sum }_{i = 0}^{L - 1} {w}_{l , i} {x}_{m L + i} \} ]}_{+} , \qquad ( 9 )$$

In the above equation (9), x_{i,m} is the i-th element of xₘ in the above equation (2), w_{l,i} is the 1-th row i-th column element of the precoding matrix W, and w_{l,L}>0 (for any l∈Λ).

Proposition 2: A necessary and sufficient condition for the design of the precoding matrix W may be that its column or row vectors are linearly independent.

In addition to propositions 1 and 2, the power constraint tr(WW^{H})=L+1 may optionally be enforced to ensure that the precoding matrix W does not affect the transmit power, where tr(⋅) is the trace operator, and [⋅]^{H} is the matrix transpose conjugate operator. Finally, it is desired that w_{l,L}>0 (for any l∈Λ) in the above equation (9).

Based on the above-assumed optional design rules/constraints, a suitable precoding matrix W for the case of L=1 may be expressed as follows:

$$W = [ \begin{matrix}\frac{1}{\sqrt{2}} & \frac{1}{\sqrt{2}} \\ - \frac{1}{\sqrt{2}} & \frac{1}{\sqrt{2}}\end{matrix} ] \qquad ( 10 a )$$

Based on the above-assumed optional design rules/constraints, a suitable precoding matrix W for the case of L=2 may be expressed as follows:

$$W = [ \begin{matrix}\frac{1}{\sqrt{2}} & - \frac{1}{\sqrt{6}} & \frac{1}{\sqrt{3}} \\ 0 & \frac{2}{\sqrt{6}} & \frac{1}{\sqrt{3}} \\ - \frac{1}{\sqrt{2}} & - \frac{1}{\sqrt{6}} & \frac{1}{\sqrt{3}}\end{matrix} ] \qquad ( 10 b )$$

Based on the above-assumed optional design rules/constraints, a suitable precoding matrix W for the case of L=3 may be expressed as follows:

$$W = [ \begin{matrix}\frac{1}{\sqrt{2}} & 0 & - \frac{1}{2} & \frac{1}{2} \\ 0 & \frac{1}{\sqrt{2}} & \frac{1}{2} & \frac{1}{2} \\ 0 & - \frac{1}{\sqrt{2}} & \frac{1}{2} & \frac{1}{2} \\ - \frac{1}{\sqrt{2}} & 0 & - \frac{1}{2} & \frac{1}{2}\end{matrix} ] \qquad ( 10 c )$$

As an example, for L=2, if x̅₀̅=1−j, x̅₁̅=−2−3j, x̅_̅{̅N̅}̅=5+4j, then x=[1, −2, . . . , 5, −1, −3, . . . , 4]^{T}. Next, x₀=[x₀, x₁, c₀]^{T}=[1, −2, c₀]^{T}, where

$${c}_{0} = {[ {max}_{l ∈ Λ} \{ - \frac{1}{{w}_{l , 2}} {\sum }_{i = 0}^{1} {w}_{l , i} {x}_{0 + i} \} ]}_{+}$$

according to the above equation (9). By using the precoding matrix W in the above equation (10b), the following is obtained

$${c}_{0} = {[ max \{ - \sqrt{3} ( \frac{1}{\sqrt{2}} \times 1 + - \frac{1}{\sqrt{6}} \times - 2 ) , - \sqrt{3} ( 0 \times 1 + \frac{2}{\sqrt{6}} \times - 2 ) , - \sqrt{3} ( - \frac{1}{\sqrt{2}} \times 1 + - \frac{1}{\sqrt{6}} \times - 2 ) \} ]}_{+} ,$$

$${c}_{0} \approx {[ max \{ \{ - 2.64 , 2.83 , - 0.19 \} \} ]}_{+} = 2.83 ,$$

such that x₀=[1, −2,2.83]^{T}. Consequently, s₀=Wx₀≈[3.16, 0, 1.74], such that so is unipolar (i.e. all its elements are greater or equal to zero and, thus, nonnegative).

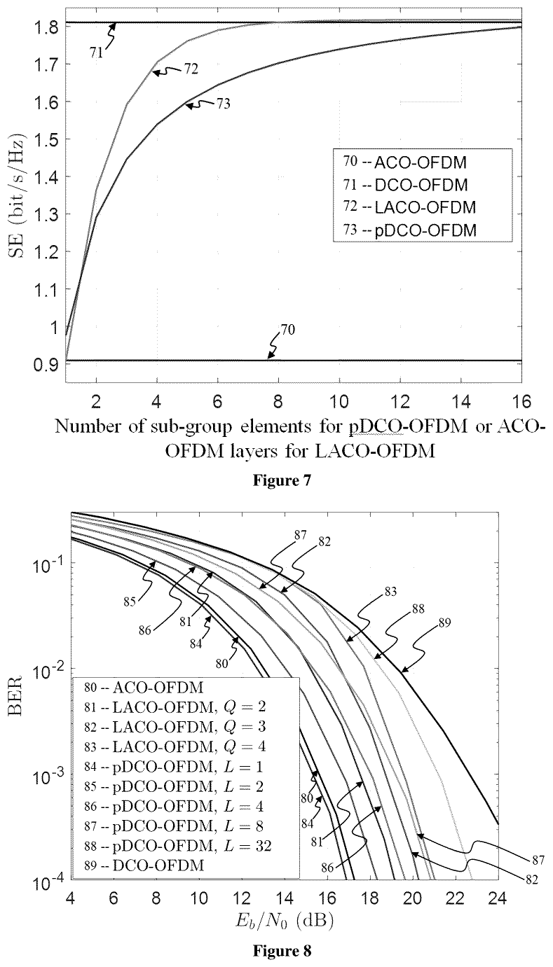

In the FIGS. 7 to 9, the scheme for generating a signal according to this disclosure, such as the steps performable by the entity according to the first aspect, the steps performable by the entity according to the second aspect, the method according to the third aspect, and the method according to the fourth aspect, may be referred to as precoded direct current-biased optical OFDM (pDCO-OFDM).

FIG. 7 shows a spectral efficiency (SE) performance for an example of O-OFDM according to this disclosure compared to ACO-OFDM, DCO-OFDM and LACO-OFDM. In particular, FIG. 7 shows the SE performance of the pDCO-OFDM scheme according to this disclosure against ACO-OFDM, DCO-OFDM and LACO-OFDM as a function of L for L=Q, M=16 (i.e. using a 16-QAM) and ϵ=0.1.

According to the example of the pDCO-OFDM scheme shown in FIG. 5, the entity 1 transmits N M-ary digital modulation symbols, carrying log₂ M bits each, by using N frequency domain subcarriers and 2N(L+1)=L+N* time domain samples. Given that the sampling time of the IFFT 502 is T=N, where the duration of one IFFT symbol, i.e. x, is T and its subcarrier spacing is 1/T, the bandwidth according to the pDCO-OFDM scheme is N=T Hz, and the duration of a transmission of N M-ary digital modulation symbols is

$$\frac{\frac{2 N ( L + 1 )}{L} + {N}^{*}}{N} T$$

seconds. Consequently, the SE of the pDCO-OFDM scheme according to this disclosure may be expressed as

$${SE}_{pDCO}^{L} = \frac{NK ( \frac{T}{N} )}{\frac{\frac{2 N ( L + 1 )}{L} + {N}^{*}}{N} T} = \frac{L K}{2 N ( L + 1 ) + ε L} , \qquad ( 11 )$$

where K=log₂ M and ε=N*/N. In comparison, the SE of ACO-, DCO- and LACO-OFDM are

$${SE}_{ACO} = \frac{K / 4}{1 + ε} , {SE}_{DCO} = \frac{K ( \frac{1}{2} - 1 / N )}{1 + ε} , and$$

$${SE}_{LACO} = \frac{( 1 - {2}^{- Q} ) K / 2}{1 + ε} bit / s / Hz ,$$

respectively, where Q is the number of layers in LACO-OFDM. Consequently, it can be remarked that

$${SE}_{pDCO}^{∞} ∼ {SE}_{DCO}$$

(when ε=0), which implies that pDCO-OFDM scheme according to this disclosure can provide a trade-off between ACO- and DCO-OFDM in terms of SE performance, by tuning the value of L.

The results in FIG. 7, which depicts the SE variations of pDCO-, ACO-, DCO-, and LACO-OFDM as a function of L, confirm the above. The vertical axis of the graph of FIG. 7 shows SE in bit/s/Hz and the horizontal axis of the graph of FIG. 7 shows the number L of sub-group elements (for pDCO-OFDM) or the number Q of ACO-OFDM layers (for LACO-OFDM). As shown in FIG. 7, the SE of the pDCO-OFDM scheme may vary from the SE of ACO-OFDM to the one of DCO-OFDM. The results of FIG. 7 also indicate that the pDCO-OFDM scheme provides a higher level of granularity in terms of SE compared to LACO-OFDM, i.e. more than double the granularity. LACO-OFDM may only provide Q=8 different levels of SE to go from ACO- to DCO-OFDM SE performance in FIG. 7, whereas the pDCO-OFDM scheme may provide more than L=16 levels of SE. This provides with regard to the pDCO-OFDM scheme more degrees of freedom for achieving a good trade-off between SE and any other performance metrics. In LACO-OFDM, Q represents the number of parallel ACO-OFDM layers used to pre-process the signal before transmitting it. Whereas, L represents the number of elements (samples) of the original signal for each precoded subgroup. That is, L is the number of elements (samples) of x in each sub-group of elements xₘ, as defined with regard to above equation (2).

FIG. 8 shows a bit-error-rate (BER) performance for an example of O-OFDM according to this disclosure compared to ACO-OFDM, DCO-OFDM and LACO-OFDM. In particular, FIG. 8 shows the BER performance of the pDCO-OFDM scheme according to this disclosure against ACO-OFDM, DCO-OFDM and LACO-OFDM as a function of E_{b}/N₀ in an additive white Gaussian noise (AWGN) channel (i.e. when h=1) for N=512 subcarriers, M=16 (i.e. using a 16-QAM), and 2048 transmitted IFFT symbols, i.e. 212 transmitted bits, as well as the CP represents 10% of the transmitted signal, i.e. ε=0.1. Note that ACO-OFDM and Q=1-layer LACO-OFDM are the same, so that Q=1-layer LACO-OFDM (i.e. LACO-OFDM, Q=1) is not shown in FIG. 8. The vertical axis of the graph of FIG. 8 shows BER and the horizontal axis of the graph of FIG. 8 shows the energy per bit to noise power spectral density ratio E_{b}/N₀ in dB.

For L=1, the pDCO-OFDM scheme is similar to a unipolar-OFDM (U-OFDM) scheme, which itself has a similar BER performance as ACO-OFDM. However, the pDCO-OFDM scheme still provides a small coding gain over ACO-OFDM due to its lower relative CP overhead (i.e. one CP every 2N(L+1)/L time domain samples are desired in pDCO-OFDM instead of one every N samples in ACO-OFDM). Whereas as L increases, as the BER performance of the pDCO-OFDM scheme becomes closer to that of DCO-OFDM. Besides, the results of FIG. 8 show that the pDCO-OFDM provides a better BER performance than LACO-OFDM (for a similar SE), especially at high BER.

For instance, according to FIG. 7, the pDCO-OFDM scheme for L=8 and the LACO-OFDM for Q=4 have a similar SE of 1.7 bit/s/Hz, yet the pDCO-OFDM scheme provides better BER performances than LACO-OFDM in FIG. 8, with higher Et/N₀ gain at higher BER values, e.g. E_{b}/N₀ gain of 0.2 dB, 1.2 dB, and 2 dB at BER of 10⁻⁴, 10⁻², and 10⁻¹, respectively. This may be due to the fact that the layer structure of LACO-OFDM tends to severely degrade the BER in the range of BER between 10⁻¹ and 10⁻².

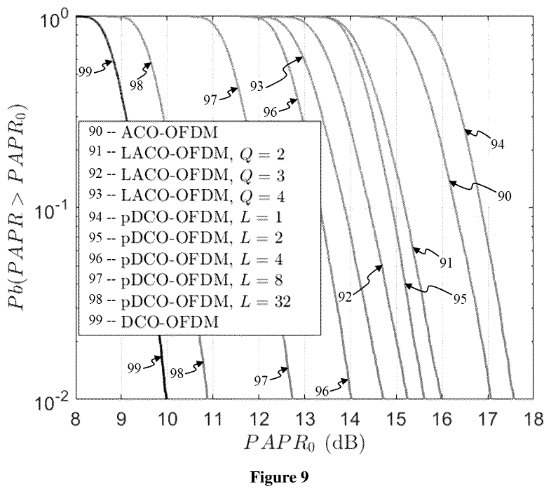

FIG. 9 shows a peak to average-power ratio (PAPR) performance for an example of O-OFDM according to this disclosure compared to ACO-OFDM, DCO-OFDM and LACO-OFDM. In particular, FIG. 9 shows the PAPR performance of the pDCO-OFDM scheme according to this disclosure against ACO-OFDM, DCO-OFDM and LACO-OFDM for N=512 subcarriers, and M=16 (i.e. using a 16-QAM).

In addition of providing a flexible means of increasing the SE of O-OFDM, the pDCO-OFDM scheme allows reducing the PAPR, as shown in FIG. 9. The FIG. 9 depicts the complementary cumulative distribution function (ccdf) of PAPR for the pDCO-OFDM scheme against ACO-, DCO-, and LACO-OFDM by showing the probability that the PAPR is greater than a given value PAPR₀. The vertical axis represents the probability that the PAPR is greater than the given value PAPR₀ (Pb(PAPR>PAPR₀)), and the horizontal axis represent the given value PAPR₀ in dB. As for the SE and BER, the PAPR performance of the pDCO-OFDM scheme gets closer to that of DCO-OFDM as L increases. Further, it is clearly shown in FIG. 9 that the pDCO-OFDM scheme provides significant PAPR performance improvement in comparison with LACO-OFDM, in addition of the BER performance improvement. As shown in FIG. 9, the pDCO-OFDM scheme may reduce the PAPR by 2.5 dB in comparison with LACO-OFDM for similar SE and BER (at high E_{b}/N₀) performances, i.e. when comparing pDCO-OFDM, L=8, with LACO-OFDM, Q=4. Besides, increasing L from 1 to 8 in the pDCO-OFDM scheme may reduce the PAPR by 7.4 dB, while a reduction of only 2.3 dB is obtained via LACO-OFDM from Q=1 to 4. Since the PAPR performance of LACO-OFDM for Q=1 and ACO-OFDM are the same, only the performance of ACO-OFDM is reported in FIG. 9. The significant PAPR performance improvement of the pDCO-OFDM scheme with respect to LACO-OFDM may be explained by DC biasing. The DC biasing allows reducing PAPR, i.e. the higher the DC offset, the lower the PAPR.

For example, let “a” be the maximum amplitude of a signal and “b” be its root mean square value, then its PAPR may simply be given by a²/b². Let now add a positive dc value “c” to this signal, then its PAPR becomes (a+c)²/(b+c)². Assuming that a≥b≥0 and c>0 it can then be easily proved that a²/b²>(a+c)²/(b+c)² since 2ab>−c(a+b). In addition, lim c->+infinity(a+c)²/(b+c)²=1.

Jointly analyzing the results of FIGS. 7 to 9, it confirms that the pDCO-OFDM scheme according to this disclosure provides a finer granularity than LACO-OFDM for trading-off SE with BER or PAPR performance.

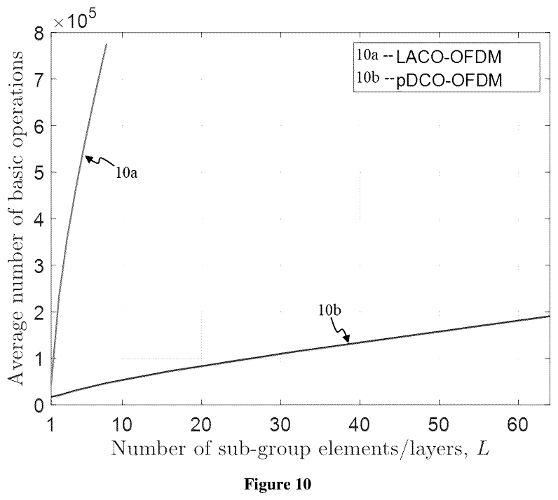

FIG. 10 shows a computational complexity for an example of O-OFDM according to this disclosure compared to LACO-OFDM. In particular, FIG. 10 illustrates the computational complexity of pDCO-OFDM and LACO-OFDM, measured in terms of the average number of basic operations (e.g. addition, subtraction, multiplication, etc.) that are necessary to transmit and receive information. The results have been obtained by transmitting 212 bits (i.e. N=512 subcarriers), using a 16-QAM (i.e. M=16), and 2048 transmitted IFFT symbols, averaged over the number of IFFT symbols. The vertical axis of the graph of FIG. 10 shows the average number of basic operations and the horizontal axis of the graph of FIG. 10 shows the number L of sub-group elements per layers. The greater the average number of basic operations the greater the computational complexity and vice versa.

The results of FIG. 10 clearly show that pDCO-OFDM outperforms LACO-OFDM in terms of computational complexity as well. For instance, the pDCO-OFDM scheme with L=8 has a computational complexity roughly one order of magnitude (i.e. 10 times) lower than LACO-OFDM, Q=4, for the same SE. The far lower complexity of the pDCO-OFDM scheme may be due to the fact that it does not require multiple IFFT/FFT operations and an iterative decoding structure as in LACO-OFDM.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An optical communication entity for generating a signal, comprising a processor or processing circuitry, wherein the processor or processing circuitry is configured to generate the signal by precoding a vector, the vector comprising a group of real elements and an offset, and
obtain the group of real elements from an orthogonal frequency-division multiplexing (OFDM) signal, and the offset from the group of real elements.

2. The optical communication entity according to claim 1, wherein
the processor or processing circuitry is configured to transmit the signal.

3. The optical communication entity according to claim 1, wherein
the processor or processing circuitry is configured to obtain the vector by
grouping samples of the OFDM signal in multiple groups, and
obtaining the offset for each group of the multiple groups.

4. The optical communication entity according to claim 1, wherein
the processor or processing circuitry is configured to precode the vector by multiplying the vector with a precoding matrix, and
column or row vectors of the precoding matrix are linearly independent.

5. The optical communication entity according to claim 1, wherein
the processor or processing circuitry is configured to obtain the vector by
separating a real part and an imaginary part of N samples of the OFDM signal, wherein N is a positive integer,
generating 2N real elements comprising the real part and imaginary part of the N samples of the OFDM signal,
grouping the 2N real elements in multiple groups, and
obtaining the offset for each group of the multiple groups.

6. The optical communication entity according to claim 1, wherein the processor or processing circuitry is configured to
transmit the signal to a second entity, and
provide to the second entity at least one of:
information on a length of the vector,
information on a precoding matrix, and
information on the offset.

7. An optical communication entity for generating an orthogonal frequency-division multiplexing (OFDM) signal, comprising a processor or processing circuitry, wherein the processor or processing circuitry is configured to generate the OFDM signal by
grouping samples of a signal in multiple groups, and
postcoding each group of the multiple groups to generate postcoded samples of the signal.

8. The optical communication entity according to claim 7, wherein
the processor or processing circuitry is configured to receive the signal.

9. The optical communication entity according to claim 7, wherein
the processor or processing circuitry is configured to generate the OFDM signal by removing from each postcoded group a respective real scalar element, which is a respective single offset.

10. The optical communication entity according to claim 9, wherein
the processor or processing circuitry is configured to concatenate each postcoded group without the removed respective real scalar element.

11. The optical communication entity according to claim 9, wherein
the processor or processing circuitry is configured to generate N samples of the OFDM signal each comprising complex values by using each postcoded group without the removed respective real scalar element.

12. The optical communication entity according to claim 7, wherein the processor or processing circuitry is configured to
receive at least one of:
information on a group length associated with a group of the multiple groups, information on a precoding matrix, and
information on a respective single offset associated with the group of the multiple groups.

13. The optical communication entity according to claim 7, wherein
the signal is a real nonnegative signal.

14. A method, performed by an optical communication entity, for generating a signal, wherein the method comprises:
generating the signal by precoding a vector, the vector comprising a group of real elements and an offset; and
obtaining the group of real elements from an orthogonal frequency-division multiplexing (OFDM) signal, and the offset from the group of real elements.

15. The method according to claim 14, further comprising:
transmitting the signal.

16. The method according to claim 14, further comprising:
obtaining the vector by
grouping samples of the OFDM signal in multiple groups; and
obtaining the offset for each group of the multiple groups.

17. The method according to claim 14, further comprising:
precoding the vector by multiplying the vector with a precoding matrix, and column or row vectors of the precoding matrix are linearly independent.

18. The method according to claim 14, further comprising:
obtaining the vector by
separating a real part and an imaginary part of N samples of the OFDM signal, wherein N is a positive integer,
generating 2N real elements comprising the real part and imaginary part of the N samples of the OFDM signal,
grouping the 2N real elements in multiple groups, and
obtaining the offset for each group of the multiple groups.

19. The method according to claim 14, further comprising:
transmitting the signal to a second entity; and
providing to the second entity at least one of:
information on a length of the vector,
information on a precoding matrix, and
information on the offset.
